(19) United States
(12) Patent Application Publication
(10) Pub. No.: US 2009/0174982 A1
(43) Pub. Date: Jul. 9, 2009

(54) CONTROLLING THE FLOW OF ELECTROSTATIC DISCHARGE CURRENTS

(76) Inventors: Edward C. Gillard, Mantorville, MN (US); Don A. Gilliland, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/971,301

(22) Filed: Jan. 9, 2008

(51) Int. Cl. H05F 3/00

(52) U.S. Cl. 361/220

(57) ABSTRACT

A method and system for controlling the electrical connection between the metallic covers and the underlying metal chassis of an electrical system by the select placement of impedances in a current control connector. The current control connector places an impedance, capable of controlling electrostatic discharge (ESD) currents, between the covers and the underlying chassis. The current control connector comprises a number of metallic and dielectric components. Each of these components is ideally chosen such that the structure and composition of each component contributes to an overall functionality of the current control connector and an ability to control the ESD current flow. The relative placement of the components of the current control connector allows the current control connector to eliminate current flow along a number of paths but control the current flow along a preferred path. Thus, the current control connector prevents damage to the internal electrical system.

### BACKGROUND

1. Technical Field

The present invention generally relates to electrical systems (ESD) currents and in particular to the control of electrostatic discharge (ESD) current flow in electrical systems.

2. Description of the Related Art

Many electrical systems experience electrostatic discharge (ESD) which generates ESD currents. The ESD currents flow in an uncontrolled manner across electronic equipment covers and into the chassis. The electronic system's immunity may be affected by the nearby ESD currents through the chassis frame or passing near sensitive circuits. Currents flowing throughout a chassis are reflected by system impedances and this current reflection causes standing waves within the chassis. These standing waves may cause subsequent radiation. The uncontrolled impedance connections at various locations between the equipment covers and the chassis contribute to the variability of the ESD response of the system.

### SUMMARY OF ILLUSTRATIVE EMBODIMENTS

Disclosed are a method and system for controlling the electrical connection between the metallic covers and the underlying metal chassis of an electrical system by the select placement of impedances in a current control connector. The current control connector places an impedance, capable of controlling electrostatic discharge (ESD) currents, between the covers and the underlying chassis. The current control connector comprises a number of metallic and dielectric components. Each of these components is ideally chosen such that the structure and composition of each component contributes to an overall functionality of the current control connector and an ability to control the ESD current flow. The relative placement of the components of the current control connector allows the current control connector to eliminate current flow along a number of paths but control the current flow along a preferred path. Thus, the current control connector prevents damage to and/or upset of the internal electrical system.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is an external view of the current control connector, according to one embodiment of the invention;

FIG. 2 illustrates a cross sectional view of the current control connector, according to one embodiment of the invention;

FIG. 3 illustrates an external view of a top isolation dielectric component, according to one embodiment of the invention;

FIG. 4 illustrates an external view of a bottom isolation dielectric component, according to one embodiment of the invention;

FIG. 5 illustrates an external view of a metallic disk component, according to one embodiment of the invention;

FIG. 6 illustrates a fully assembled current control connector, according to one embodiment of the invention; and

FIG. 7 is a flow chart illustrating the process of selecting various dielectric and metallic components and assembling a current control connector with the selected components, according to one embodiment of the invention.

### DETAILED DESCRIPTION OF AN ILLUSTRATIVE EMBODIMENT

The illustrative embodiments provide a method and system for controlling the electrical connection between the metallic covers and the underlying metal chassis of an electrical system by the select placement of impedances in a current control connector. The current control connector places an impedance, capable of controlling electrostatic discharge (ESD) currents, between the covers and the underlying chassis. The current control connector comprises a number of metallic and dielectric components. Each of these components is ideally chosen such that the structure and composition of each component contributes to an overall functionality of the current control connector and an ability to control the ESD current flow. The relative placement of the components of the current control connector allows the current control connector to eliminate current flow along a number of paths but control the current flow along a preferred path. Thus, the current control connector prevents damage to the internal electrical system.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

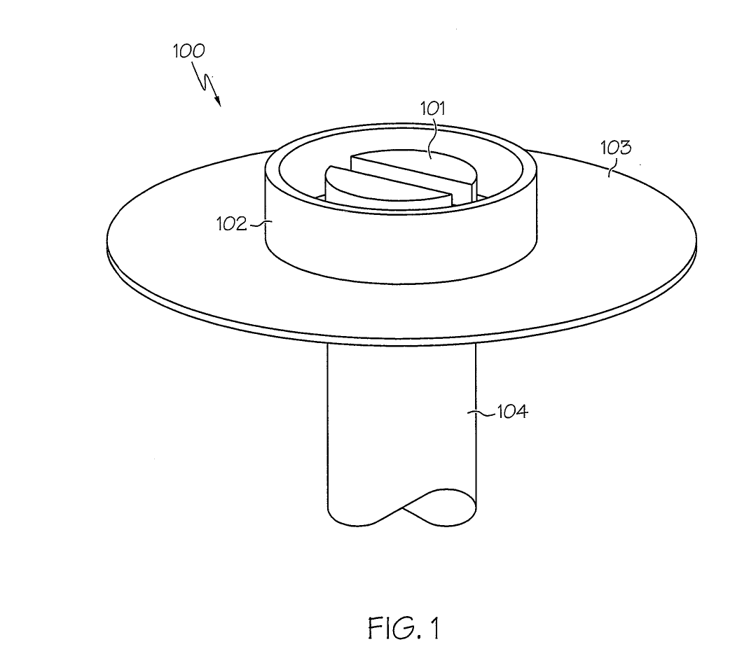

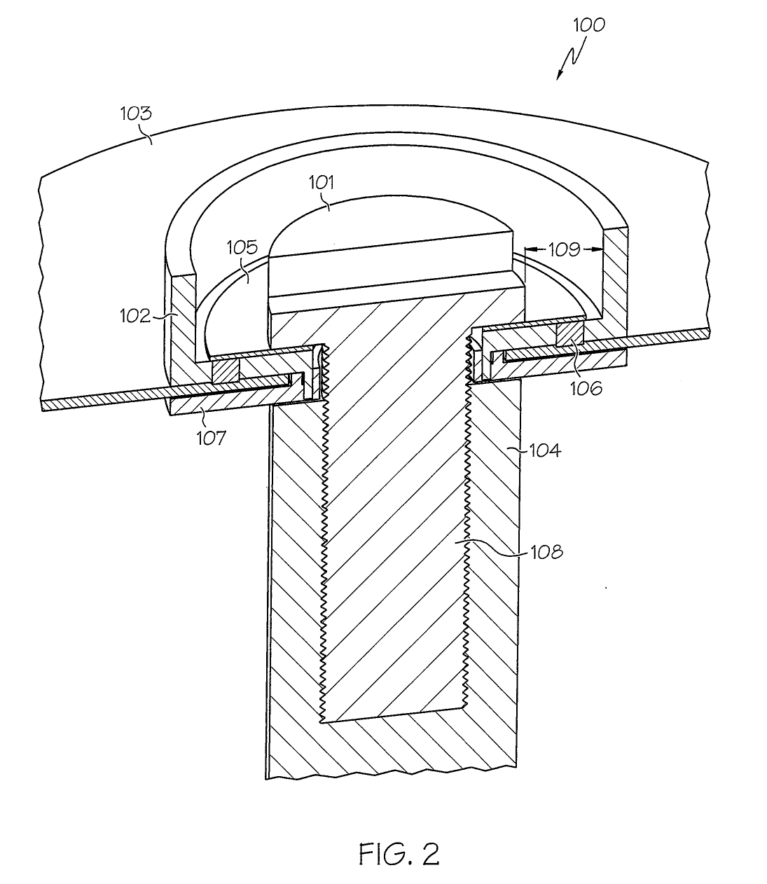

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

With reference now to FIG. 1, there is depicted an external view of the current control connector, according to one embodiment of the invention. Current Control Connector 100 comprises a screw, of which, the head (of the screw) is illustrated as screw head 101. Current control connector 100 also includes top (isolation) dielectric plate 102. Current control connector 100 also comprises a section of a protective cover for an electrical system, illustrated as cover 103. Also included in current control connector 100, is dielectric insulation 104.

In current control connector 100, a screw is utilized to assembly cover 103 to a chassis (not explicitly shown in FIG. 1). Current control connector is specially configured to control an ESD current flow between the metallic covers and the underlying metal chassis of an electrical system through controlled impedance connections. The illustrated components are described in more detail in the following illustrative embodiments.

Among the steps that are executed in order to realize the current control connector, and which are specific to the invention, are: (a) selecting a group of dielectric and metallic components, each with a particular structure, which when assembled together, controls an ESD current flow; (b) assembling the current control connector with the group of dielectric and metallic components; and (c) controlling the ESD current flow, based on a relative placement of the components within the current control connector. Current control connector 100 is designed to enable a number of current control features, which are described below within the description of FIGS. 2-7.

Those of ordinary skill in the art will appreciate that the hardware and basic configuration depicted in FIG. 1 and the other figures may vary. The depicted example is not meant to imply architectural limitations with respect to the present invention.

FIG. 2 illustrates a cross sectional view of current control connector 100, according to one embodiment of the invention. Current Control Connector 100 comprises a screw which further comprises a head (of the screw), illustrated as screw head 101, and screw core 108. Current control connector 100 also includes top isolation component 102. Current control connector 100 also comprises a section of a protective cover for an electrical system, illustrated as cover 103. Also included in current control connector 100, is dielectric insulation 104.

In current control connector 100, screw head 101 rests partially upon metallic disk 105. Metallic disk 105 rests directly upon top isolation component 102. In addition, metallic disk 105 remains affixed in place by metallic insert(s) 106, a section of disk 105 which is inserted inside a hole(s) within top isolation component 102. Top isolation component 102 rests partially upon cover 103. Metallic insert(s) 106 rests directly upon cover 103, which cover 103 further rests partially upon bottom isolation component 107. As a result of the relative placement and structure of the components in current control connector 100, a space (109) exists above a section of metallic disk 105, adjacent to screw head 101, and also adjacent to a section of top isolation component 102.

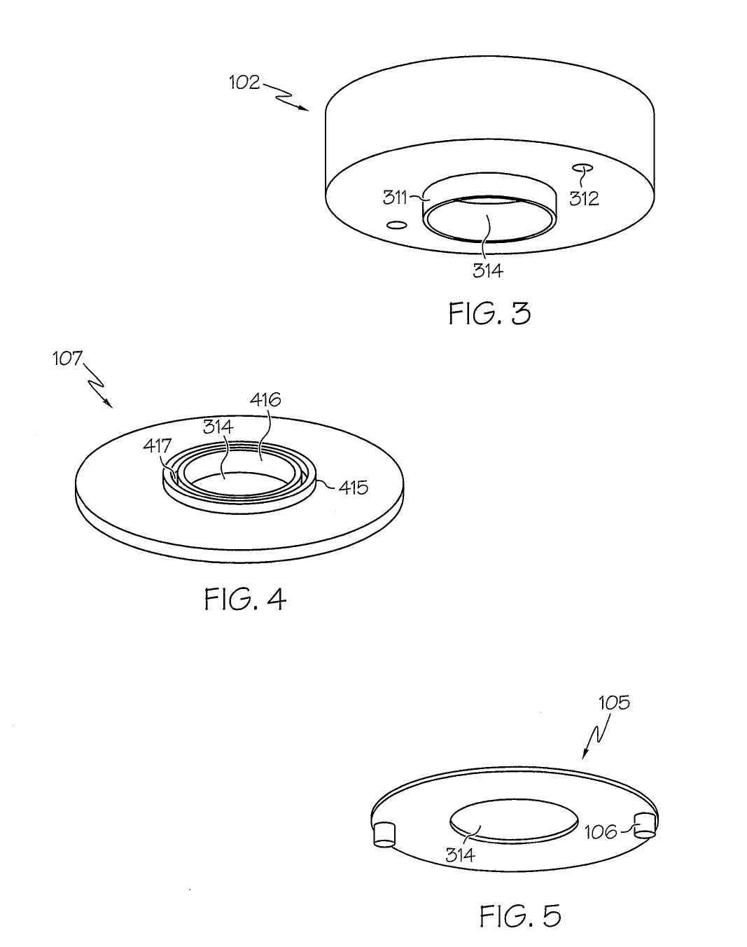

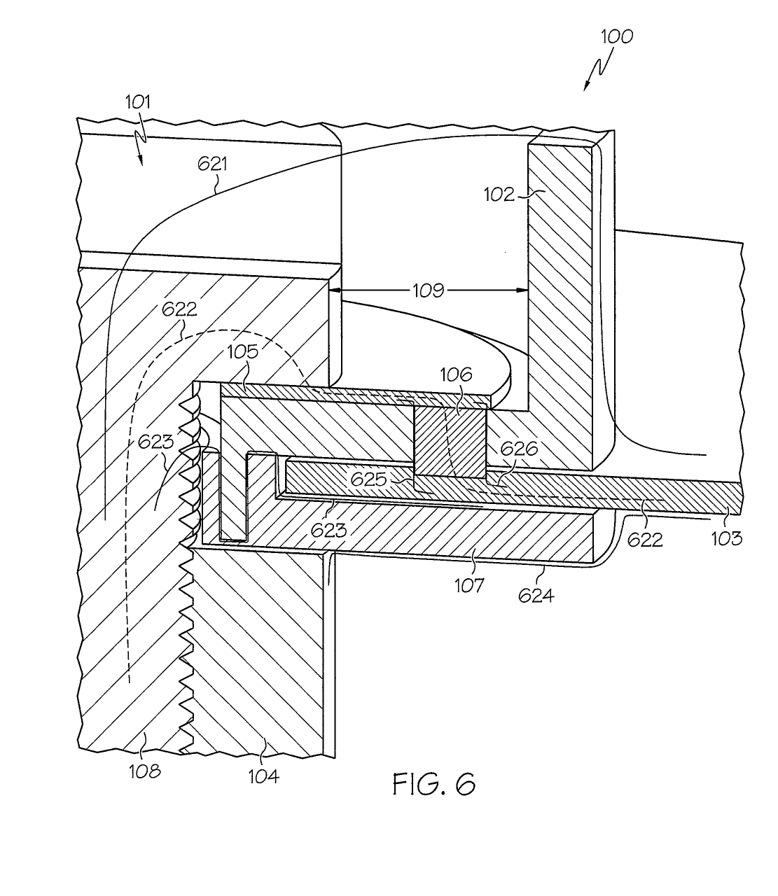

A complete explanation of current control connector 100 is facilitated with a further view of current control connector 100, depicting a preferred current path, presented in the illustration of FIG. 6. FIGS. 3-5 illustrate a number of the key individual components of current control connector 100.

With reference now to FIG. 3, an external view of a top isolation component is illustrated, according to one embodiment of the invention. Top isolation component 102 is a dielectric component which represents a high impedance component within the configuration of current control connector 100. Top isolation component 102 includes a main cylindrical section and a smaller cylindrical ring (illustrated as cylindrical ring 311) located at a main opening (illustrated as main opening 314). Top isolation component 102 also comprises a number of secondary holes/openings, of which secondary opening 312 is illustrated.

FIG. 4 illustrates an external view of a bottom isolation component, according to one embodiment of the invention. Bottom isolation component 107 is a dielectric component which represents a high impedance component within the configuration of current control connector 100. Bottom isolation component 107 comprises a number of cylindrical sections, of which inner (cylinder) section 416 and outer (cylinder) section 415 are illustrated. The relative locations of inner (cylinder) section 416 and outer (cylinder) section 415 create a shallow channel, illustrated as shallow (channel) section 417 within bottom isolation component 107.

FIG. 5 illustrates an external view of a metallic disk component, according to one embodiment of the invention. Component 105 is a resistive component within the configuration of current control connector 100. Component 105 comprises a number of solid resistive cylindrical sections, illustrated as resistive metallic insert(s) 106.

FIG. 6 illustrates a fully assembled current control connector, according to one embodiment of the invention. Current control connector 100 comprises a screw which further comprises screw head 101 and screw core 108. Screw head 101 rests partially upon metallic disk 105. Metallic disk 105 rests directly upon top isolation component 102. Disk 105 remains affixed in place by metallic insert(s) 106, a section of disk 105 which is inserted inside a hole(s) within top isolation component 102. Top isolation component 102 rests partially upon cover 103. Metallic insert(s) 106 rests directly upon cover 103. Cover 103 rests partially upon bottom isolation component 107. In connector 100, cylindrical ring 311 of component 102 fits into a shallow channel (417) of bottom isolation component 107. As a result of the relative placement and structure of the components in current control connector 100, a space (109) exists above a section of metallic disk 105, adjacent to screw head 101, and also adjacent to a section of top isolation component 102. Also included in current control connector 100 is dielectric insulation 104 into which screw core 108 is inserted. Additionally, a section of bottom isolation component 107 rests upon dielectric insulation 104.

A number of ESD current paths are also illustrated in current control connector 100. Some of the illustrated ESD current paths are undesired paths which are unlikely as a result of the structure of current control connector 100. These paths are undesired because ESD current flow along these paths may cause damage to the internal electrical system. The composition of various components within current control connector 100 contributes to the elimination of these unlikely paths. In order to provide a reference, these paths are illustrated in current control connector 100. Specifically, these unlikely paths are illustrated as follows: (1) first unlikely path 621; (2) second unlikely path 623; (3) third unlikely path 625; (4) fourth unlikely path 626; and (5) fifth unlikely path 624.

On the other hand, a desired path of a controlled flow of an ESD current is preferred path 622. Thus, as current flow is eliminated in the unlikely current paths, a controlled ESD current flow is directed along preferred path 622.

With the design of current control connector 100, ESD currents are prevented from traveling through the undesired high impedance paths. The ESD currents travel instead through an ideal lower resistance (i.e., more conductive) path to reach the chassis. In current control connector 100, arcing is prevented by increasing the distances of any potential arc path, and by employing dielectric components with higher impedance levels within the potential arc path. Thus, the unlikely arc paths are effectively eliminated within current control connector 100. More specifically, the distances of the arc paths are set to be large enough to prevent the flow of ESD currents, given a designated voltage level.

ESD current flow is eliminated along first unlikely path 621, which path 621 includes a section from screw head 101 to top isolation component 102 via space 109. The form of top isolation component 102 is ideally chosen to create a relatively large (high impedance) space (109). In addition, unlikely path 621 is eliminated with the aid of the high impedance characteristic (resulting from the dielectric composition) of top isolation component 102. The ESD current is provided a relatively lower impedance path (illustrated as preferred path 622) from screw head 101, through metallic disk 105, then through insert(s) 106 and along cover 103. The metallic composition of insert(s) 106 ideally connects ESD currents from resistive disk 105 to cover 103. As current takes the path of least resistance, current flow is severely restricted through third unlikely path 625 and fourth unlikely path 626, but flows through metallic insert(s) 106 which is adjacent to both third unlikely path 625 and fourth unlikely path 626. Third unlikely path 625 and fourth unlikely path 626 indicate paths which may include short arc paths adjacent to both insert(s) 106 and top isolation component 102. ESD current flow along second unlikely path 623 is also eliminated by the intrinsically higher impedance of second unlikely path 623 as compared with the relatively low impedance of preferred path 622. Similarly, the relatively high impedance of fifth unlikely path 624 eliminates ESD current flow. Fifth unlikely path 624 includes a section of dielectric insulator 104 and a section of bottom isolation component 107 which contribute to the relatively high impedance of fifth unlikely path 624. Ultimately, preferred path 622 is the designated path for the flow of ESD currents.

In current control connector 100, component structures are essentially lengthened to prevent arcing to the low impedance structures forcing the current through the resistance. The non-metallic (dielectric) plates are connected to collectively increase the ESD discharge distance that forces the current through the resistive metallic disk. The metallic disk itself is relatively conductive and directs the current to redundant metallic inserts that provide the ESD current pathway. For installation in a system where the chassis is closely spaced to the covers, a dielectric (insulator) is placed upon the chassis surface to prevent any uncontrolled secondary discharge paths.

In current control connector 100, since arcing is prevented along these higher impedance paths, ESD currents follow a lower impedance path that is provided through the resistive material on the disks and then through the screw body. The screw is not altered in any way but the current flow and current path provided by current control connector (100) between the cover and the chassis are controlled. Although one embodiment is presented as a configured connection(s) between the covers and the chassis, in yet another embodiment, the connection may also be implemented between chassis sections to limit current flow through the center of the machine to provide added protecting against any damaging effects (to key internal components) that may be caused by ESD currents.

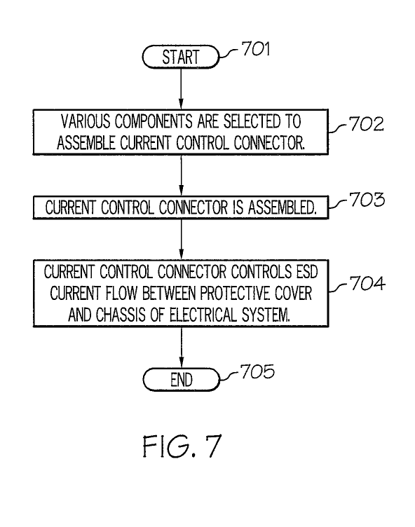

Although current control connector 100 described in FIG. 7 may be described with reference to components shown in FIGS. 1-6, it should be understood that this is merely for convenience and alternative components and/or configurations thereof can be employed when implementing the method.

FIG. 7 is a flow chart illustrating the above process of selecting various dielectric and metallic components and assembling current control connector 100 (FIG. 1, 6) with the selected components, according to one embodiment of the invention. Although the method illustrated in FIG. 7 may be described with reference to components shown in FIGS. 1-6, it should be understood that this is merely for convenience and alternative components and/or configurations thereof can be employed when implementing the method.

The process of FIG. 7 begins at initiator block 701 and proceeds to block 702, at which various metallic and dielectric components are selected to assemble current control connector 100. The unique forms and compositions of the various metallic and dielectric components collectively provide the intended functionality of current control connector 100. At block 703, current control connector is assembled (and implemented) by the relative placement of the various metallic and dielectric components. Current control connector 100 eliminates ESD current flow along a number of unlikely paths but controls the flow of ESD current along a preferred path, as shown at block 704. The process ends at block 705.

In the flow chart above, the method is executed as a series of steps. In some implementations, certain steps of the method are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for creating a current control connector for controlling ESD current flow, the method comprising:
selecting one or more components for the current control connector from among:
(1) a screw comprised of a screw head and a screw core;
(2) one or more metallic disks, wherein each one of said metallic disks includes a main opening to accommodate the screw core, wherein each one of said metallic disk includes one or more metallic inserts to direct a current along a pre-determined pathway, wherein said metallic inserts facilitate a secure fastening of a number of components within the current control connector;
(3) a top isolation component composed of a dielectric material, wherein said top isolation component includes a main cylindrical section, a main opening to accommodate the screw core, a cylindrical ring located at a periphery of the main opening, and one or more secondary openings to accommodate the one or more metallic inserts from each one of the one or more metallic disks;
(4) a bottom isolation component composed of a dielectric material, wherein said bottom isolation component includes a main opening to accommodate the screw core, an inner cylindrical section located at a border of the main opening, and an outer cylindrical section, wherein said inner cylindrical section and said outer cylindrical section are connected to create a shallow channel, wherein said channel accommodates the cylindrical ring from the top isolation component; and
(5) a dielectric insulator with a lined opening which allows said dielectric insulator to accommodate a turning action of the screw and a size of the screw core wherein said turning action securely and substantially places the screw core into the opening of the dielectric insulator;
choosing each one of the components of the current control connector such that a structure and a composition of each one of the components contribute to an overall structure of an assembled current control connector, which controls the ESD current flow;
providing a secure and stationary current control connector by a relative placement of the components of the current control connector;
assembling the current control connector to allow an ESD current to flow along an intended path which path includes one or more of the following: (1) a protective cover of an electronic system; (2) a metallic insert from the metallic disk; (3) the metallic disk; and (4) the screw.

2. The method of claim 1, wherein said providing further comprises:
fastening the dielectric insulator to a chassis of the electrical system;
securely placing the bottom isolation component in a position with a bottom side of the bottom isolation component directly connected to the dielectric insulator and a top side of the bottom isolation component securely connected to an inner side of a protective cover;
securely inserting the top isolation component in a position which places the cylindrical ring of the top isolation component into the shallow circular channel of the bottom isolation component, wherein a section of said top isolation component is adjacent to an outer side of the protective cover;
securely placing the resistive disk adjacent to the top side of the top isolation component, wherein the inserts from said resistive disk securely fits into the secondary openings within the top isolation component and said inserts also connect directly to the protective cover at the outer side of the protective cover;
securing a number of adjacent component connections within the current control connector prior to an insertion of the screw; and
inserting the screw into the main opening to securely fasten the protective cover to the chassis.

3. The method of claim 1, wherein said choosing further comprises:
selecting the set of components of the current control connector, wherein each one of the components of said current control connector has a particular structure and a set of appropriate physical dimensions coupled with a corresponding chemical composition, which when each one of the said components is assembled within the current control connector, contributes to (a) a controlled flow of an ESD current along a set of intended current paths and to (b) the prevention of a generation of one or more current arc paths, in the control connector which is constructed to safely handle a specified maximum voltage level, which voltage level may occur at one or more locations within the current control connector.

4. A current control connector system comprising:
a screw which fastens a protective cover to a chassis of an electrical system;
a number of dielectric and metallic components, which collectively provide the functionality of the current control connector system, said components including:
(1) a screw comprised of a screw head and a screw core;
(2) one or more metallic disks, wherein each one of said metallic disks includes a main opening to accommodate the screw core, wherein each one of said metallic disk includes one or more metallic inserts to direct a current along a predetermined pathway, wherein said metallic inserts facilitate a secure fastening of a number of components within the current control connector;
(3) a top isolation component composed of a dielectric material, wherein said top isolation component includes a main cylindrical section, a main opening to accommodate the screw core, a cylindrical ring located at a periphery of the main opening, and one or more secondary openings to accommodate the one or more metallic inserts from each one of the one or more metallic disks;
(4) a bottom isolation component composed of a dielectric material, wherein said bottom isolation component includes a main opening to accommodate the screw core, an inner cylindrical section located at a border of the main opening, and an outer cylindrical section, wherein said inner cylindrical section and said outer cylindrical section are connected to create a shallow channel, wherein said channel accommodates the cylindrical ring from the top isolation component; and
(5) a dielectric insulator with a lined opening which allows said dielectric insulator to accommodate a turning action of the screw and a size of the screw core wherein said turning action securely and substantially places the screw core into the opening of the dielectric insulator;
wherein each one of the components of the current control connector are chosen such that the structure and a composition of the chosen components contribute to an overall structure of the assembled current control connector which controls the ESD current flow;
wherein a secure and stationary current control connector is provided by a relative placement of the components of the current control connector;
wherein the current control connector is assembled to allow an ESD current to flow along an intended path which path includes one or more of the following: (1) a protective cover of an electronic system; (2) a metallic insert from the metallic disk; (3) the metallic disk; and (4) the screw.

5. The system of claim 4:
wherein the dielectric insulator is fastened to the chassis of an electrical system;
wherein the bottom isolation component is securely placed in a position with a bottom side of the bottom isolation component directly connected to the dielectric insulator and a top side of the bottom isolation component securely connected to an inner side of the protective cover;
wherein the top isolation component is securely placed in a position which places the cylindrical ring of the top isolation component into the shallow circular channel of the bottom isolation component, wherein a section of said top isolation component is adjacent to an outer side of the protective cover;
wherein the resistive disk is securely placed adjacent to the top side of the top isolation component, wherein the inserts from said resistive disk securely fits into the secondary openings within the top isolation component and said inserts also connects directly to the protective cover at the outer side of the protective cover;
wherein a number of adjacent component connections are secured within the current control connector prior to an insertion of the screw; and
wherein the screw is inserted into the main opening to securely fasten the protective cover to the chassis.

6. The system of claim 4, wherein:
the set of components of the current control connector are selected, such that each one of said components of said current control connector has a particular structure and a set of appropriate physical dimensions coupled with a corresponding chemical composition, which when each one of the said components is assembled within the current control connector, contributes to (a) a controlled flow of an ESD current along a set of intended current paths and to (b) the prevention of a generation of one or more current arc paths, in the control connector which is constructed to safely handle a specified maximum voltage level, which voltage level may occur at one or more locations within the current control connector.

7. A device comprising:
a chassis;
an electrical system which is assembled on and is structurally supported by the chassis;
a protective cover for the electrical system;
a screw which fastens the protective cover to the chassis of the electrical system;
a number of dielectric and metallic components, which collectively provide the functionality of a current control connector system, which includes one or more components from among:
(1) a screw comprised of a screw head and a screw core;
(2) one or more metallic disks, wherein each one of said metallic disks includes a main opening to accommodate the screw core, wherein each one of said metallic disk includes one or more metallic inserts to direct a current along a pre-determined pathway, wherein said metallic inserts facilitate a secure fastening of a number of components within the current control connector;
(3) a top isolation component composed of a dielectric material, wherein said top isolation component includes a main cylindrical section, a main opening to accommodate the screw core, a cylindrical ring located at a periphery of the main opening, and one or more secondary openings to accommodate the one or more metallic inserts from each one of the one or more metallic disks;
(4) a bottom isolation component composed of a dielectric material, wherein said bottom isolation component includes a main opening to accommodate the screw core, an inner cylindrical section located at a border of the main opening, and an outer cylindrical section, wherein said inner cylindrical section and said outer cylindrical section are connected to create a shallow channel, wherein said channel accommodates the cylindrical ring from the top isolation component; and
(5) a dielectric insulator with a lined opening which allows said dielectric insulator to accommodate a turning action of the screw and a size of the screw core wherein said turning action securely and substantially places the screw core into the opening of the dielectric insulator;
wherein each of the components of the current control connector are chosen such that the structure and a composition of the chosen components contribute to an overall structure of the assembled current control connector which controls the ESD current flow;
wherein a secure and stationary current control connector is provided by a relative placement of the components of the current control connector;
wherein the current control connector is assembled to allow an ESD current to flow along an intended path which path includes one or more of the following: (1) a protective cover of an electronic system; (2) a metallic insert from the metallic disk; (3) the metallic disk; and (4) the screw.

8. The device of claim 7:
wherein the dielectric insulator is fastened to the chassis of the electrical system;
wherein the bottom isolation component is securely placed in a position with a bottom side of the bottom isolation component directly connected to the dielectric insulator and a top side of the bottom isolation component securely connected to an inner side of the protective cover;
wherein the top isolation component is securely placed in a position which places the cylindrical ring of the top isolation component into the shallow circular channel of the bottom isolation component, wherein a section of said top isolation component is adjacent to an outer side of the protective cover;
wherein the resistive disk is securely placed adjacent to the top side of the top isolation component, wherein the inserts from said resistive disk securely fits into the secondary openings within the top isolation component and said inserts also connects directly to the protective cover at the outer side of the protective cover;
wherein a number of adjacent component connections are secured within the current control connector prior to an insertion of the screw; and
wherein the screw is inserted into the main opening to securely fasten the protective cover to the chassis.

9. The device of claim 7, wherein:
the set of components of the current control connector are selected, such that each one of said components of said current control connector has a particular structure and a set of appropriate physical dimensions coupled with a corresponding chemical composition, which when each one of the said components is assembled within the current control connector, contributes to (a) a controlled flow of an ESD current along a set of intended current paths and to (b) the prevention of a generation of one or more current arc paths, in the control connector which is constructed to safely handle a specified maximum voltage level, which voltage level may occur at one or more locations within the current control connector.
